(19) United States
(12) Patent Application Publication
(10) Pub. No.: US 2011/0204545 A1
(43) Pub. Date: Aug. 25, 2011

(54) METHOD OF MAKING HIGH PERFORMANCE SEALS

(76) Inventors: Douglas E. Tanner, Copake, NY (US); Craig Busby, Sherman, CT (US)

(21) Appl. No.: 12/712,976

(22) Filed: Feb. 25, 2010

(51) Int. Cl. B29C 43/20

(52) U.S. Cl. 264/250

(57) ABSTRACT

A method of making a high performance seal wherein an uncured elastomeric material is tightly encapsulated in a tubular section of uncured perfluoroelastomer, where the elastomeric material and the perfluoroelastomer are chosen to have similar cure characteristics. The uncured encapsulation is formed into a desired shape for the seal, and vulcanized under heat and pressure.

### FIELD OF THE INVENTION

The invention relates to seals, particularly seals in the nature of O-rings, X-rings e.g., four-lobed rings, gumdrop seals and compression seals of various custom designed cross sections, especially for applications in which the seal is exposed to severe temperature and/or chemical conditions.

### BACKGROUND OF THE INVENTION

Where O-rings and similar sealing elements are exposed to relatively extreme conditions of temperature and/or chemical exposure, conventional elastomeric materials tend to deteriorate quickly and thus involve excessive maintenance. As a result, various attempts have been made to employ special high performance materials, such as perfluoroelastomers (FFKM) for such seals. While FFKM has outstanding chemical and temperature resistance, it is an expensive material and it is somewhat lacking in the level of resilience that is desired for many sealing applications.

Various attempts have been made to combine FFKM elastomers with less costly and/or more resilient materials. In the Tanaka et al U.S. Pat. No. 6,730,385, for example, a perfluoro rubber was combined with other rubber, using a polyfunctional adhesive coating between the two materials, preferentially “primarily” vulcanizing one of the materials before laminating to improve dimensional accuracy, and thereafter laminating and vulcanizing the combined materials.

In the Proper U.S. Pat. No. 6,918,595, a high pressure pump seal for gas chromatography applications is formed by wrapping the end of a cylindrical membrane, formed of an FFKM material about an O-ring of softer, more resilient elastomeric material, such that the only material contacting surfaces of the pump is the FFKM. This arrangement minimizes contamination of the chromatographic examination by the softer but less resistant material of the O-ring, while taking advantage of the elastic characteristics of the O-ring material.

In the Okoroafor international publication WO 2007/096664, there is shown an O-ring structure comprised of a central body of an elastomer such as FKM, formed over a reinforcing spring by compression or injection molding, after which, in a separate transfer molding operation, a thin (0.1-0.3 mm) coating of FFKM is formed about the central body.

In European Patent Application EP 1 852 902, for example, FFKM perfluoroelastomer is mixed with FKM, together with a cross linking agent in a range of 80-50% FFKM to 20-50% FKM, to achieve a homogeneous mixture taking properties from each of the primary components. Although the mixture had some of the advantages of each major component, it also had some of the disadvantages of the other component, and thus is a less than satisfactory compromise.

### SUMMARY OF THE INVENTION

The present invention provides a simplified and economical co-molding procedure for the manufacture of high performance seals utilizing combinations of a perfluoroelastomer (FFKM) externally for temperature and chemical resistance and other, more resilient elastomers internally for improved sealing performance. Combining the materials can occur one of two ways. Either an outer jacket of the perfluoroelastomer is formed and is loaded with an inner core of the softer material, either as part of a co-extrusion process or in a subsequent operation; or the outer layer is calendered to a specified wall thickness then wrapped around an uncured inner core. The combined materials are then formed to the shape of the desired seal, placed in a compression mold, and cured under heat and pressure to form an integral unit. Use of a co-agent within both layers promotes the cross-linking between the two during vulcanization. Examples include triallyl isocyanurate (TAIC) and trimethylallyl isocyanurate. A lower cost product is realized, as compared to an all-FFKM seal, while improved performance is achieved.

### BRIEF DESCRIPTION OF THE DRAWINGS

FIG. 1 is a cross sectional view of one preferred form of seal material made in accordance with the procedures of the invention.

FIG. 2 is a longitudinal section as taken along line 2-2 of FIG. 1.

FIG. 3 is a plan view of a typical O-ring formed with the seal material of FIGS. 1 and 2.

FIG. 4 is a cross sectional view of a second preferred form of seal material used in the formation of a gumdrop seal.

### DETAILED DESCRIPTION OF THE INVENTION

The process of the invention is particularly useful in connection with the manufacture of various temperature- and chemical-resistant seals, such as O-rings, lobed rings, such as X-rings, gumdrop seals, and various customized forms of compression seals. The process is unique in providing for the co-molding of an FFKM outer layer together with a more resilient core, without the requirement of adhesives or special bonding agents, to realize a particularly advantageous combination material useful particularly in connection with the manufacture of sealing elements with excellent service life under severe conditions while having improved sealing characteristics. The process involves an initial encapsulation of a resilient elastomer within a sheath or jacket of an FFKM, configuring the encapsulation product to form the desired seal (e.g., an O-ring), and then curing (vulcanizing) the product under heat and pressure in a compression mold.

A wide variety of commercially available FFKM products are suitable for use in connection with the invention. Examples of such are “KALREZ”, a product of DuPont Performance Elastomers, “SIMRIZ”, a product of Freudenberg-NOK, “CHEMRAZ”, a product of Greene Tweed and “DYNEON”, a product of Dyneon LLC (3M). The named products are registered trademarks of their respective manufacturers. Likewise, a wide variety of elastomers are suitable for the encapsulated core material. By way of example, suitable core materials may be various fluoroelastomers (FKM), fluorosilicones, silicone, EPDM, nitrile, and neoprene. Importantly, the perfluoroelastomer and the core elastomer must have similar and compatible cure types and characteristics, including incorporation of a cross linking co-agent such as TAIC, for proper bonding during the compression molding process. Typically, the FFKM is subject to peroxide or free radical curing, in which case the core is selected from materials that are also subject to peroxide curing.

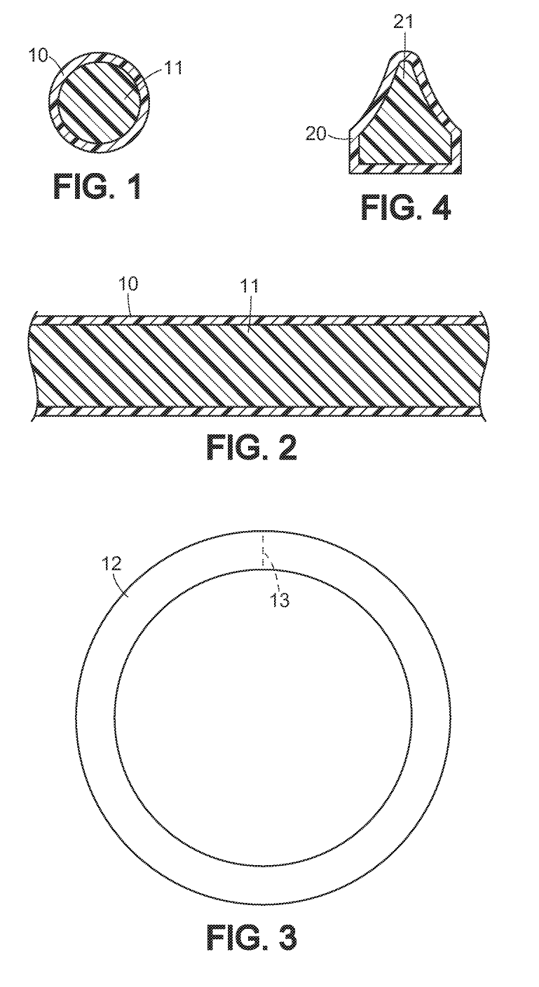

In the process according to the invention, the uncured FFKM component is either extruded in the form of an elongated tube 10 of suitable cross sectional contour—typically but not necessarily cylindrical, as shown in FIGS. 1 and 2, or calendered to a specified thickness. For a typical form of O-ring seal, an extruded tube 10 of FFKM material may have a wall thickness of, for example, 0.020 inch and an inside diameter typically in the range of about 0.100 inch to 0.5 inch. The extruded tube 10 is packed with a selected core elastomer 11, such as fluoroelastomer (FKM), fluorosilicone, silicone, EPDM, nitrile or neoprene. The core material can be selected for its desired characteristics, such as resiliency, cost, etc., but in all events must be of a cure type and have curing characteristics similar to those of the encapsulating perfluoroelastomer material. The core material 11 may be injected into the encapsulating tube 10, completely filling it, or may, in appropriate cases, be co-extruded within the surrounding tube 10. An outer layer 10 of calendered FFKM may also be wrapped around the uncured core material 11. No adhesive or special bonding agent is required or used at the interface between the core material and the encapsulating tube.

To form a circular seal using the above-described material, a section of the combined encapsulating and core materials, as set forth above, with both components thereof still in the uncured state, is cut to a predetermined length and formed into a desired circular shape 12, as shown in FIG. 3, with opposite ends of the length being positioned in tightly abutted relation, as shown at 12 in FIG. 3. The circular shape is then placed in a compression mold having a suitable circular cavity where it is subjected to heat and pressure sufficient to effect curing (vulcanization) of the materials while simultaneously bonding the FFKM tube with the core material at the interface thereof to form an integral unit.

Seals made in accordance with the invention can be of a wide variety of sizes and shapes. By way of example and not of limitation, FIG. 4 illustrates a gumdrop seal, in which the thin-walled tubular sheath 20 of FFKM material is extruded in a gumdrop configuration and packed with uncured core material 21 of a more resilient elastomer, such as referenced above, either by a co-extrusion procedure or a subsequent injection of the uncured core material into the tubular sheath.

Curing time and temperature is a function of the specific materials utilized and the size and cross section of the article. However, for a typical O-ring, a curing time of 20-45 minutes at about 320-350° F. is appropriate. For a given combination of materials, and a given size of article, it is a simple matter for one skilled in the art to determine optimum times and temperatures for effective curing. To advantage, the secondary or core material is completely encapsulated by its perfluoroelastomer jacket or casing prior to the curing process. When the co-molded article is in the form of a ring or other closed shape, complete encapsulation is provided by the closing and butting together of the opposite ends of the section of filled tubular sheath. For non-closed shapes, however, it is desired and preferred that opposite ends of the tubular sheath be sealed closed, such that the core material is fully encapsulated before curing takes place, with the item being cut to final length after curing.

It will be understood that the specific forms of the invention illustrated and described here are intended to be representative and not limiting of the invention. Accordingly, reference should be made to the appended claims in determining the full scope of the invention.

What is claimed is:

1. A co-molding process for making a sealing element incorporating a perfluoroelastomer externally and a secondary, more resilient elastomeric core material internally, which comprises,
(a) forming a wall section of uncured perfluoroelastomer having a predetermined wall thickness,
(b) forming an uncured elastomeric core material of greater resilience than said perfluoroelastomer
(c) forming a curable composite material by tightly surrounding said core material with a layer of said uncured perfluoroelastomer,
(c) selecting said perfluoroelastomer and said elastomeric core material to have similar and compatible cure characteristics, including the incorporation therein of cross linking agents and co-agents.
(d) forming a section of said curable composite material into an encapsulation form in which the elastomeric core material is substantially encapsulated by said perfluoroelastomer, and
(e) placing said encapsulation form into a compression mold and applying heat and pressure for a sufficient time to effect curing and mutual bonding of said perfluoroelastomer and said elastomeric core material.

2. The process of claim 1, wherein
(a) said section of uncured perfluoroelastomer material is formed by extruding a tubular length of said uncured perfluoroelastomer and packing a section of said tubular length with an uncured elastomeric core material.

3. A process according to claim 2, wherein
(a) said uncured perfluoroelastomer material and said uncured elastomeric material are co-extruded in the form of a core of uncured elastomeric material surrounded by a tube of perfluoroelastomer.

4. A process according to claim 1, wherein
(a) said wall section of uncured perfluoroelastomer is formed by calendering said material to a predetermined thickness, and
(b) said wall section of uncured perfluoroelastomer is wrapped around said uncured elastomeric core material.

5. The method of claim 1, wherein
(a) said predetermined length is converted to said encapsulation form by forming said predetermined length into a circular configuration and placing opposite ends of said length in butting contact to close said ends prior to applying said heat and pressure.

6. The method of claim 5, wherein the cross sectional configuration of said extruded length is substantially circular.

7. The method of claim 5, wherein the cross sectional configuration of said extruded length is gumdrop shaped.

8. The method of claim 1, wherein said elastomeric core is selected from the group consisting of fluoroelastomers, fluorosilicones, silicone, EPDM, nitrile and neoprene.
